(19) United States
(12) Patent Application Publication
(10) Pub. No.: US 2026/0210802 A1
(43) Pub. Date: Jul. 23, 2026

(54) METHOD AND DEVICE FOR MONITORING A ROTARY MACHINE ON THE BASIS OF A VIBRATORY SIGNAL

(71) Applicant: SAFRAN, Paris (FR)

(72) Inventors: Dany ABBOUD, Moissy-Cramayel (FR); Mohammed EL BADAOUI, Moissy-Cramayel (FR); Fadi KARKAFI, Moissy-Cramayel (FR)

(73) Assignee: SAFRAN, Paris (FR)

(21) Appl. No.: 19/141,854

(22) PCT Filed: Dec. 18, 2023
(86) PCT No.: PCT/FR2023/052034

§ 371 Date: Jun. 20, 2025

(30) Foreign Application Priority Data
Dec. 21, 2022 (FR) 2214143

(51) Int. Cl. G01M 15/02

(52) U.S. Cl. CPC G01M 15/02

(57) ABSTRACT

This invention relates to a method for monitoring a rotary machine (MAC) based on a vibration signal (SIG), the rotary machine (MAC) comprising a plurality of subsystems (S_{A}-S_{B}) of mechanical parts in rotation (L_{A1}-L_{A2}, L_{B1}-L_{B2}) and the vibration signal (SIG) comprising vibrational contributions of the subsystems (S_{A}-S_{B}), the method comprising, for at least one said subsystem (S_{A}), steps consisting in:
estimating (S210) the vibrational contribution of said subsystem (S_{A}) from a set of synchronous averages of the vibration signal (SIG) associated with rotation frequencies (F_{A1}-F_{A2}) of the parts of said subsystem (S_{A}) and with multiples of these rotation frequencies (F_{A1}-F_{A2});
determining (S310) whether or not said subsystem (S_{A}) is faulty by comparative analysis of a so-called health indicator corresponding to the estimated vibrational contribution (SIG_{A}) of said subsystem (S_{A}).

### TECHNICAL FIELD

This invention relates to the field of monitoring of mechanical systems. More specifically, this invention relates to a method for monitoring a rotary machine, and associated monitoring device, system, aircraft and program. This invention has an especially beneficial, though in no way limiting, application for the implementation of monitoring systems of motors for aircraft.

### PRIOR ART

The invention is situated in the specific context of the monitoring of rotary machines by analysis of vibration signals. The vibration signals generated by a rotary machine advantageously allow to monitor the operation of the rotary machine. Specifically, these signals comprise a good deal of information about the faults that can affect the different mechanical parts of the rotary machine.

In this context, a monitoring system has the aim of detecting, based on a measured vibration signal, a fault in the rotary machine (e.g. damage of a part). Thus, the reliability of such a monitoring system remains a major issue for many applications such as aerospace. However, the monitoring of a rotary machine by vibrational analysis requires the exploitation of a vibration signal comprising a multitude of contributions from different vibration sources.

Hence, a rotary machine (e.g. an aircraft engine) is composed of many subsystems respectively comprising several mechanical parts in rotation. The measured vibration signal thus comprises the vibrational contributions of each of the different parts of the rotary machine which, moreover, can interfere with one another. To the measured vibrational signal can also be added random contributions related to various types of noise. Thus, to specifically monitor the operation of a subsystem of interest of the rotary machine, it is necessary to extract the contribution of this subsystem from the vibration signal.

The existing solutions for separating the sources in a vibration signal can in particular be divided into two categories. Firstly, certain solutions rely on an assumption of statistical independence between the different sources of vibrations to separate them from one another. By way of example, the document

CN102519582B illustrates such a solution making use of principle-component analysis. Nevertheless, the strong correlations between the vibrational contributions of the different sources mean that the assumption of statistical independence is not verified, and render these solutions inaccurate.

Secondly, these solutions of the prior art make use of the frequency components of the measured vibration signal to separate different vibration sources. Such a solution is for example shown in the document CN105910701A. To separate the vibration sources, these solutions assume that the frequency components of the different sources are disjunct. However, this is not the case. The parts of a rotary machine interfere with one another and hence the vibrational contributions of different parts comprise shared frequency components. Thus, the assumption used by these solutions leads to errors in the estimation of the vibrational contribution of a source of interest.

Finally, the existing solutions do not allow to accurately estimate the contribution of one of the vibration sources of a rotary machine. As a result, the reliability of the existing solutions for detecting, by vibrational analysis, a fault in a subsystem of a rotary machine is not fully satisfactory.

Consequently, there is a need for a monitoring solution allowing, from a vibrational signal of a rotary machine, to reliably determine whether or not a subsystem of the rotary machine is faulty.

### SUMMARY OF THE INVENTION

This invention has the aim of remedying all or part of the drawbacks of the prior art, particularly those set out previously.

According to an aspect of the invention, provision is made for a method for monitoring a rotary machine based on a vibration signal, the rotary machine comprising a plurality of subsystems of mechanical parts in rotation and the vibration signal comprising vibrational contributions of the subsystems, the method comprising, for at least one said subsystem, steps consisting in:
estimating the vibrational contribution of said subsystem from a set of synchronous averages of the vibration signal comprising:
   first synchronous averages (of the vibration signal) associated with rotation frequencies of the parts of said subsystem; and
   one or more second synchronous averages (of the vibration signal) associated with multiples of the rotation frequencies of the parts of said subsystem, these multiples being shared by at least two parts of said subsystem;
determining whether or not said subsystem is faulty by comparative analysis of a so-called health indicator corresponding to the estimated vibrational contribution of said subsystem.

In the context of the invention, the term “vibration signal” is used to denote a signal representative of the vibration of the rotary machine being monitored. For example, the vibration signal can be acquired by way of an accelerometer mounted on the rotary machine.

It should be noted that the rotation frequencies (i.e. rotation speeds) of the mechanical parts of the rotary machine can be defined in an absolute manner (e.g. 10 000 rpm) or in a relative manner, in relation to the rotation frequency of a reference shaft (e.g. 2×f_{ref}). Hereinafter, the ratio of the rotation frequency of any part to the rotation frequency of the reference shaft is denoted by the term “order”.

Furthermore, the term “multiple of a rotation frequency” should be understood to mean a product of the rotation frequency by an integer strictly greater than 1. A multiple of a rotation frequency is also hereinafter denoted by the term “harmonic”. Moreover, a multiple f is said to be shared by two parts, the respective rotation frequencies of which are f₁ and f₂, if there are two integers k and p greater than 1 such that f=k·f₁ and f=p·f₂+ε, with |a|<Δ a margin of error related to a numerical approximation.

To estimate the vibrational contribution of a subsystem of the rotary machine comprising several mechanical parts in rotation, this invention makes provision for using the synchronous averages of the vibration signal respectively associated with the rotation frequencies of the parts of the subsystem—the so-called first synchronous averages. Each of these synchronous averages can be used to extract the frequency components (i.e. the fundamental frequency and the harmonics) from the vibrational contribution of one of the parts of the subsystem. Moreover, provision is made for using the synchronous averages of the vibration signal associated with multiples of the rotation frequencies (i.e. the harmonics, the orders) shared by several parts of the subsystem-said second synchronous averages, which allows to take into account the interference between the vibrational contributions of these parts.

Unlike the aforementioned existing solutions, this invention relies neither on an assumption of statistical independence between vibration sources, nor on an assumption of disjunct frequency components between the vibration sources. In this sense, the solution for which provision is made can be described as a non-parametric solution of source separation and allows to take into account the interference between the parts of the rotary machine. Consequently, by comparison with the existing solutions, the solution for which provision is made allows to more accurately estimate the vibrational contribution of a subsystem of a rotary machine.

Thus, the solution for which provision is made allows to extract (i.e. to isolate), from the measured vibration signal, the vibrational contribution of a subsystem of the rotary machine. Hence, the solution for which provision is made allows to reliably determine (particularly in terms of probability of correct detection and probability of false alert) if this subsystem is faulty (e.g. comprises a damaged part).

This invention is particularly advantageous in that it allows early detection of a fault in the rotary machine and thus avoids the propagation of damage caused by one part to other parts of the rotary machine.

According to an embodiment, the monitoring method comprises for each of the subsystems of the rotary machine steps consisting in: estimating the vibrational contribution of said subsystem of the acquired vibration signal; and determining whether or not said subsystem is faulty by comparative analysis of a so-called health indicator corresponding to the estimated contribution of said subsystem.

This embodiment is especially advantageous in that it allows to individually monitor each of the subsystems of the rotary machine. If the rotary machine has a fault, this embodiment allows to identify the faulty subsystems and schedule appropriate maintenance.

According to an embodiment, the vibrational contribution of said subsystem is estimated based on a difference between: a sum of said first synchronous averages;

and a sum of said one or more second synchronous averages.

In this embodiment, provision is made for using the sum of said first synchronous averages of the vibration signal associated with the rotation frequencies of the parts of the subsystem. This sum allows to extract the frequency components (i.e. the fundamental frequency and the harmonics) of the vibrational contributions of the parts of the subsystem.

Furthermore, provision is made for eliminating the replication of the interference between the parts of the subsystem, and to do so by subtracting said second synchronous averages from the vibration signal of the rotary machine associated with the shared harmonics (i.e. with the shared orders). Specifically, by summing the vibrational contributions of each of the parts of the subsystem, the frequency components shared by several parts (characterizing the interference between these parts) are taken into account several times.

This embodiment allows to accurately estimate the vibrational contribution of a subsystem of the vibration signal of the rotary machine.

According to an embodiment, the estimated contribution of said subsystem is expressed by:

$${x}_{A} ( u ) = {\sum }_{{f}_{i} ∈ {F}_{A}} {m}_{x} ( {f}_{i} , u ) - {\sum }_{{f}_{i} ∈ {F}_{A}} {{\sum }_{{f}_{i} ∈ {F}_{A}}}_{{f}_{j} > {f}_{i}} {m}_{x} ( φ ( {f}_{i} , {f}_{j} ) , u ) ,$$

with: u, a time-domain or angular index; F_{A}, the rotation frequencies of the parts of said subsystem; φ(fᵢ,fⱼ), the lowest frequency multiple of fᵢ and of fⱼ; and mₓ(fᵢ,u) the synchronous average of the vibration signal x(u) associated with the frequency fᵢ and defined by:

$${m}_{x} ( {f}_{i} , u ) = \frac{1}{N} {\sum }_{n = 0}^{N - 1} x ( u - n \cdot {M}_{{f}_{i}} ) ,$$

where N is a number of averaged samples of the vibration signal x(u), and M_{fi} is a number of samples of the vibration signal x(u) for a period associated with the frequency fᵢ.

The synchronous average associated with φ(fᵢ,fⱼ), the lowest frequency that is a multiple of the rotation frequencies fᵢ and fⱼ of two parts of the subsystem, allows to extract the harmonics (i.e. the orders) shared by these two parts. These shared harmonics are representative of the interference between the vibrational contributions of these parts.

Consequently, according to this embodiment, the vibrational contribution of the subsystem is obtained by summing the vibrational contributions of each of the parts, then by eliminating the replication of the interference between these contributions.

According to an embodiment, the monitoring method comprises for at least one part of said subsystem, steps consisting in:
estimating the vibrational contribution of said part from a set of synchronous averages of the estimated vibrational contribution of said subsystem comprising:
   a third synchronous average (of the estimated vibrational contribution of said subsystem) associated with a rotation frequency of said part; and
   one or more fourth synchronous averages (of the estimated vibrational contribution of said subsystem) associated with multiples of the rotation frequency of said part, these multiples being shared by said part and by at least one other part of said subsystem;
determining whether or not said part is faulty by comparative analysis of a so-called health indicator corresponding to the estimated contribution of said part.

In this embodiment, to estimate the vibrational contribution of one of the parts of the subsystem, provision is made for using the synchronous average of the vibration signal associated with the rotation frequency of said part-said third synchronous average. This synchronous average allows to extract the frequency components (i.e. the fundamental frequency and the harmonics) of the vibrational contribution of the part under consideration.

Moreover, provision is made for using the synchronous averages of the vibration signal associated with multiples of the rotation frequency (i.e. the harmonics, the orders) shared by said part under consideration and by the other parts of the subsystem-said second synchronous averages. This allows to take into account the interference between the part under consideration and the other parts of the subsystem.

This embodiment allows to extract, from the vibration signal of the rotary machine, the exclusive contribution of one of the parts of a subsystem of the rotary machine and to reliably determine whether or not this part is faulty.

According to an embodiment, the monitoring method comprises for each of the parts of the subsystem, steps consisting in: estimating the vibrational contribution of the part from the estimated vibrational contribution of the subsystem; and determining whether or not the part is faulty by comparative analysis of a so-called health indicator corresponding to the estimated contribution of said part.

This embodiment is particularly advantageous in that it allows to individually monitor each of the parts of the subsystem. Hence, if the subsystem is faulty, this embodiment allows to identify the part or parts of the subsystem exhibiting a fault.

According to an embodiment, the vibrational contribution of said part is estimated based on a difference between: said third synchronous average; and a sum of said one or more fourth synchronous averages.

In this embodiment, said third synchronous averages associated with the rotation frequency of the part under consideration is used to extract the frequency components (i.e. the fundamental frequency and harmonics) of the vibrational contribution of the part.

Provision is furthermore made, to isolate the exclusive vibrational contribution of the part under consideration, for eliminating the interference between the part under consideration and the other parts of the subsystem, and for doing so by subtracting said fourth synchronous averages associated with shared harmonics (i.e. shared orders).

Thus, this embodiment allows to accurately estimate the vibrational contribution of a part of a subsystem of the rotary machine from the vibrational contribution of this system.

According to an embodiment, the estimated contribution of said part is expressed by:

$${x}_{A 1} ( u ) = {m}_{{x}_{A}} ( {f}_{A 1} , u ) - {{\sum }_{{f}_{j} ∈ {F}_{A}}}_{{f}_{j} \neq {f}_{A 1}} {m}_{{x}_{A}} ( φ ( {f}_{A 1} , {f}_{j} ) , u )$$

with: u, a time-domain or angular index; f_{A1}, the rotation frequency of said part; F_{A}, the rotation frequencies of the parts of said subsystem; φ(f_{A1},fⱼ), the lowest frequency that is a multiple of f_{A1} and of fⱼ; and mₓ_{_{A}}(fᵢ,u), the synchronous average of the estimated vibrational contribution x_{A}(u) of said subsystem (S_{A}) associated with the frequency fᵢ and defined by:

$${m}_{{x}_{A}} ( {f}_{i} , u ) = \frac{1}{N} {\sum }_{n = 0}^{N - 1} {x}_{A} ( u - n \cdot {M}_{{f}_{i}} )$$

where N is a number of averaged samples of the estimated vibrational contribution x_{A}(u), and M_{fi} is a number of samples of the estimated vibrational contribution x_{A}(u) for a period associated with the frequency fᵢ.

The synchronous average associated with φ(f_{A1},fᵢ), the lowest frequency that is a multiple of the rotation frequencies f_{A1} and fᵢ, allows to extract the harmonics (i.e. the orders) shared by the part under consideration and by another part of the subsystem and representative of the interference between these two parts.

The exclusive vibrational contribution of the part under consideration is, according to this embodiment, obtained by: determining the vibrational contribution of the part under consideration (including the interference with other parts); then by eliminating the interference with the other parts of the subsystem.

According to an embodiment, if a fault in a said subsystem is detected, the monitoring method comprises for each of the parts of the subsystem a step consisting in determining whether or not the part is faulty by comparative analysis of a so-called health indicator corresponding to the estimated contribution of said part.

This embodiment is advantageous in that it allows to accurately locate a fault in the rotary machine. Specifically, if a subsystem of the rotary machine is faulty, this embodiment allows to identify the part or parts of the subsystem exhibiting a fault.

According to an embodiment, a fault is detected if a root mean square of a said estimated contribution is greater than a threshold.

More precisely, a subsystem is determined to be faulty if a root mean square of the estimated vibrational contribution of said subsystem is greater than a threshold; and a part is determined to be faulty if a root mean square of the estimated vibrational contribution of said part is greater than a threshold.

According to this embodiment, a health indicator corresponding to an estimated vibrational contribution of a subsystem or of a part is a root mean square of the estimated vibrational contribution of the subsystem or of the part. Thus, a fault is detected whether or not this health indicator is greater than a threshold.

This embodiment allows to reliably detect whether or not a subsystem or a part has a fault by comparative analysis of a so-called health indicator corresponding to its estimated vibrational contribution. Specifically, if a part or a subsystem is faulty, the fault will cause a greater vibration.

According to an embodiment, the monitoring method comprises a step of angular resampling of the vibration signal by interpolation of the vibration signal with respect to a reference signal representative of the rotation of a reference shaft of the rotary machine. In particular, note that the rotations of the parts of said subsystem are related to the rotation of the reference shaft.

The periodicity of the vibration signal of the rotary machine is intrinsically related to the rotation of the rotary machine. In the steady-state response, the rotation of the rotary machine is regular and the periodicity of the vibration signal is constant over time. However, in practice, the rotation speed of the rotary machine undergoes fluctuations. Thus, if these fluctuations are not taken into account when the vibration signal is analyzed, it can result in errors in the estimation of the vibrational contribution of a subsystem or of a part.

For this part, provision is made in this embodiment for resampling the vibration signal by interpolating it with respect to the signal representative of the rotation of a reference shaft. This embodiment allows to take into account the fluctuations of the rotation speed of the rotary machine when estimating a vibrational contribution of a subsystem or of a part.

This embodiment allows to improve the accuracy of the estimation of a vibrational contribution of a subsystem or of a part from the vibration signal of the rotary machine.

According to an embodiment, the monitoring method comprises, if a fault in a subsystem is detected, a step consisting in supplying an alert signal comprising at least one identifier and the estimated vibrational contribution of the faulty subsystem.

The alert signal may further comprise: an identifier and the estimated vibrational contribution of a faulty part of said subsystem.

This embodiment allows to indicate the presence of a fault of the rotary machine and to identify the faulty subsystem, and in particular the faulty part. In addition, by supplying the vibrational contribution associated with the detected fault, this embodiment allows to simplify the characterization of this fault.

For example, the alert signal can be supplied to a rendering device comprising a screen, which allows to simplify the characterization of a fault affecting the subsystem of the part. Specifically, the vibrational contribution of a damaged part can be representative of repetitive shocks, which can be easily identifiable on a screen.

In a variant, one could also envision supplying the alert signal to a control device of the rotary machine.

According to an aspect of the invention, provision is made for a device for monitoring a rotary machine based on a vibration signal, the device comprising:
an estimating module configured to estimate the vibrational contribution of a subsystem of the rotary machine from a set of synchronous averages of the vibration signal comprising:
   first synchronous averages (of the vibration signal) associated with rotation frequencies of the parts of said subsystem; and
   one or more second synchronous averages (of the vibration signal) associated with multiples of the rotation frequencies of the parts of said subsystem, these multiples being shared by at least two parts of said subsystem; and
a fault detecting module configured to determine whether or not a said subsystem is faulty by comparative analysis of a so-called health indicator corresponding to the estimated contribution of said subsystem.

According to an embodiment, the monitoring device implements all or part of the steps of the monitoring method for which provision is made.

According to an aspect of the invention, provision is made for a monitoring system comprising: an acquiring device configured to acquire a vibration signal; and a monitoring device in accordance with the invention.

The monitoring system may further comprise a rendering device comprising: a screen; and/or a loudspeaker. Such a rendering device is configured to render an alert signal supplied by the monitoring device if a fault is detected.

According to an embodiment, the acquiring device comprises: an accelerometer; and/or a microphone. For example, the accelerometer can be mounted on a fixed part of the rotary machine being monitored, or the microphone can be placed near it.

The acquiring device may further comprise a tachometer allowing to measure the rotation frequency of a reference shaft of the rotary machine.

According to an aspect of the invention, provision is made for an aircraft comprising a rotary machine and a monitoring system in accordance with the invention.

In the context of the invention, the term “aircraft” denotes any device capable of rising and moving through the air, such as an aircraft, a helicopter, a drone, etc.

According to an embodiment, the rotary machine is a combustion engine or an internal combustion engine.

According to an aspect of the invention, provision is made for a computer program comprising instructions for implementing the steps of a monitoring method in accordance with the invention, when the computer program is executed by at least one processor or one computer.

The computer program can be formed of one or more sub-parts stored in one and the same memory or in separate memories. The program can use any programming language, and be in the form of source code, object code, or intermediate code between source code and object code, such as in a partially compiled form, or in any other desirable form.

According to an aspect of the invention, provision is made for an information medium readable by a computer comprising a computer program in accordance with the invention.

The information medium can be any entity or device capable of storing the program. For example, the medium may comprise a storage means, such as a non-volatile memory or ROM, for example a CD-ROM or a microelectronic circuit ROM, or else a magnetic recording means, for example a diskette or a hard disk. Moreover, the storage medium can be a transmissible medium such as an electrical or optical signal, which can be conveyed via an electrical or optical cable, by radio or by a telecommunication network or by a computer network or by other means. The program according to the invention can in particular be downloaded over a computer network. Alternatively, the information medium can be an integrated circuit in which the program is incorporated, the circuit being suitable for executing or for being used in the execution of the method in question.

The monitoring device, the monitoring system, the aircraft, the computer program and the information medium for which provision is made have the advantages described above in relation to the monitoring method for which provision is made.

### BRIEF DESCRIPTION OF THE DRAWINGS

Other features and advantages of this invention will become apparent from the description supplied hereinafter, illustrating embodiments of the invention given by way of example and without any limitation, with reference to the attached drawings:

FIG. 1 shows an example of software and hardware architecture of an aircraft comprising a rotary machine and a monitoring system according to an embodiment of the invention;

FIG. 2 shows steps of a method for monitoring a rotary machine according to an embodiment of the invention;

FIG. 3A and FIG. 3B show steps of a method for monitoring a rotary machine according to an embodiment of the invention; and

FIG. 4 shows an example of a functional architecture of a monitoring device of a rotary machine according to an embodiment of the invention.

### DESCRIPTION OF THE EMBODIMENTS

This invention is applicable, in particular, to the monitoring of rotary machines installed on board aircraft. The following description of the invention will refer to this particular context, which is given solely by way of illustrative example and does not limit the invention, this invention being applicable to the monitoring of any rotary machine.

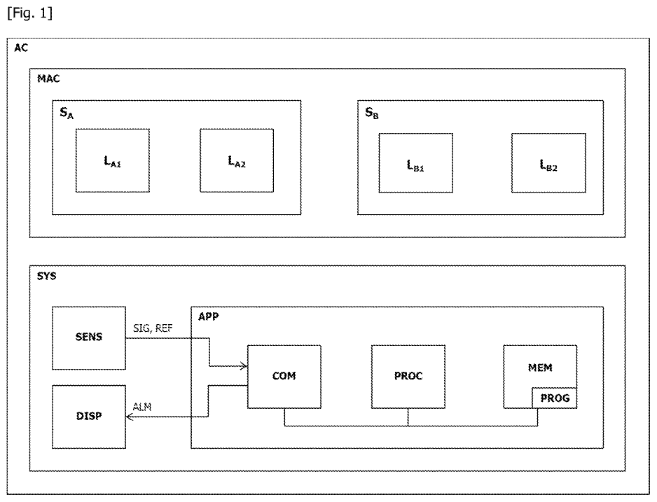

FIG. 1 shows an example of software and hardware architecture of an aircraft comprising a rotary machine and a monitoring system according to an embodiment of the invention.

The aircraft AC illustrated on FIG. 1 comprises: a rotary machine MAC; and a monitoring system SYS configured to monitor the operation of the rotary machine MAC.

The rotary machine MAC comprises: a plurality of subsystems S_{A}-S_{B}, each of these subsystems S_{A}-S_{B} comprising a plurality of mechanical parts L_{A1}-L_{A2}, L_{B1}-L_{B2} in rotation.

By way of indication, the rotary machine MAC can be a combustion engine (e.g. a turbojet engine), an internal combustion engine, a compressor, etc. A subsystem S_{A}-S_{B} may in particular be a gearbox, an airplane gearbox, or a tail gearbox of a helicopter. In addition, the parts L_{A1}-L_{A2} may for example belong to the following set of parts: a drive shaft, an alternator, a toothed wheel, a bearing, or a blade.

For the sake of simplicity, only two subsystems of two parts are illustrated on FIG. 1. However, this invention is of course applicable to any number of subsystems in the rotary machine and to any number of parts in rotation in a subsystem.

It is important to emphasize that the rotary machine MAC is associated with a kinematic linkage, and that this kinematic linkage defines the different frequencies (i.e. speeds) of rotation of the mechanical parts of the rotary machine MAC. Typically, the rotation frequencies of the parts of the rotary machine MAC are expressed in an integer number of rpms.

In particular, it should be noted that the rotations of the parts of the rotary machine MAC are related to the rotation of a reference shaft of the rotary machine MAC. For this reason, the rotation frequencies of the parts may be defined in a manner relative to the rotation frequency of the reference shaft. For example, f_{A1}=L_{A1}·f_{ref} with: f_{A1}, the rotation frequency of a part L_{A1}; and f_{ref}, the rotation frequency of the reference shaft (in particular constant in the steady-state response, and potentially variable in the transient response). In this case, the term “order” denotes the ratio L_{A1} of the rotation frequency f_{A1} of a part L_{A1} to the rotation frequency f_{ref} of the reference shaft.

Thus, each part of the rotary machine MAC is characterized by a rotation frequency (i.e. speed). More specifically, when a part in rotation has a fault, then the fault manifests in the vibration signal SIG at the rotation frequency of the part as well as in its harmonics (i.e. the multiples of the rotation frequency). For example, if a toothed wheel of a gear has a fault (e.g. a broken or damaged tooth), then the fault causes an increase in the vibration of the toothed wheel which can be observed at the rotation frequency of the toothed wheel and at the harmonics.

However, it should be underlined that certain harmonics can be common to several parts L_{A1}-L_{A2} of a subsystem S_{A} and thus characterize the interference between the vibration contribution of these parts L_{A1}-L_{A2}. By way of example, let us consider a subsystem S_{A} comprising: a first part L_{A1} with a rotation frequency 2f_{ref}; and a second part L_{A2} with a rotation frequency 3 f_{ref}. Then, according to this example, the harmonics shared by the vibrational contributions of the parts L_{A1} and L_{A2} are as follows: 6 f_{ref}, 12 f_{ref}, 18f_{ref}, . . . <Fₛ/2; or, equivalently, the orders shared by the vibrational contributions of the parts L_{A1} and L_{A2} are as follows: 6, 12, 18, . . . <Fₛ/2 f_{ref}.

The monitoring system SYS comprises: an acquiring device SENS configured to acquire a vibration signal SIG of the rotary machine MAC; and a monitoring device APP configured to monitor the operation of the rotary machine MAC based on the vibration signal SIG.

In the context of the invention, it can be envisioned to use the monitoring system SYS to monitor different types of rotary machines, for example on board an aircraft as illustrated on FIG. 1 or on a test bench.

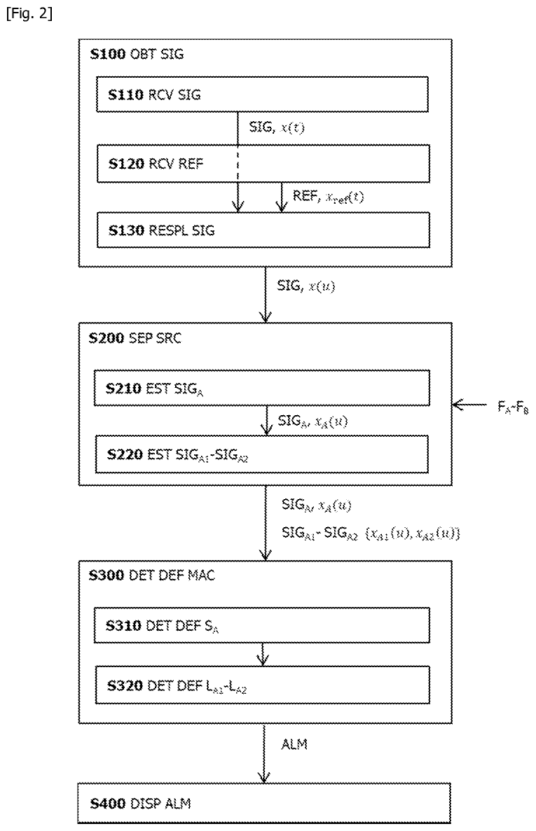

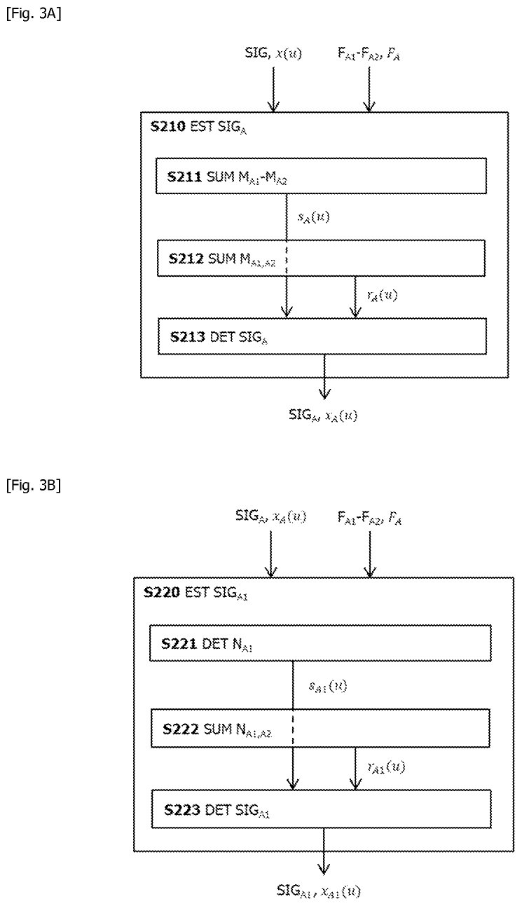

More specifically, the monitoring device APP is configured to detect a fault of the rotary machine MAC (e.g. a damaged part). For this purpose, the monitoring device APP is configured to: take as input the vibration signal SIG of the rotary machine MAC; and if a fault is detected, supply as output an alert signal ALM. The operation of the monitoring device APP is described in more detail hereinafter with reference to FIGS. 2 and 3A-3B.

According to the embodiment illustrated by FIG. 1, the monitoring system SYST further comprises a rendering device DISP configured to render the alert signal ALM supplied by the monitoring device DISP.

The acquiring device SENS is configured to acquire (i.e. measure) over a given duration a vibration signal SIG generated by the rotary machine MAC during its operation.

It should be emphasized that the measured vibration signal SIG comprises the vibrational contributions of the different parts L_{A1}-L_{A2}, L_{B1}-L_{B2} of the rotary machine MAC and, moreover, random contributions related to various types of noise, coming for example from aerodynamic or electromagnetic sources.

In particular, the acquiring device SENS may comprise an accelerometer mounted on a fixed part, or a microphone placed near the rotary machine MAC. However, in the context of the invention, it could be envisioned to use any type of signal acquired by a sensor and representative of the vibration of the rotary machine MAC during its operation.

The acquiring device SENS particularly comprises an acquisition line able to digitize (or to amplify and filter) the (analog) signal acquired by the accelerometer or a microphone.

Hereinafter x(t) denotes the digital vibration signal SIG available at the output of the acquiring device SENS. The signal x(t) is a time-domain signal sampled with a sampling frequency Fₛ and the length of the signal x(t) depends on the duration of the measurement taken by the acquiring device SENS.

According to an embodiment, the acquiring device SENS further comprises a tachometer used to measure the frequency (i.e. speed) of rotation of the reference shaft. The acquiring device SENS is thus configured to supply, to the monitoring device APP, a reference signal REF (also known as the tachometric signal) written x_{ref}(t) and representative of the rotation of the reference shaft. The reference signal REF can in particular be used to resample the vibration signal SIG as described hereinafter with reference to FIG. 2.

The rendering device DISP is configured to render the alert signal ALM supplied by the monitoring device APP if a fault of the rotary machine MAC is detected.

According to an embodiment, the alert signal ALM comprises at least one element from among the following: an identifier of a faulty subsystem; the vibrational contribution associated with the faulty subsystem; an identifier of a faulty part; and the vibrational contribution associated with the faulty part.

The rendering device DISP may comprise a screen allowing to display the identifier of the subsystem and/or of the part having a fault and to visualize the vibrational contribution associated with this fault. The rendering device DISP can further comprise a loudspeaker.

However, in the context of the invention, embodiments could also be envisioned according to which the monitoring device APP supplies, if a fault is detected, an alert signal ALM to a control device of the rotary machine MAC or of the aircraft AC.

The monitoring device APP comprises, according to the embodiment illustrated by FIG. 1: at least one processing unit or processor PROC; and at least one memory MEM.

More particularly, the monitoring device APP possesses, according to an embodiment, the hardware architecture of a computer. In this regard, the monitoring device APP may comprise a processor PROC, a random-access memory, a read-only memory MEM, and a non-volatile memory. The memory MEM associated with the device APP constitutes an information medium in accordance with the invention, readable by a computer and by the processor PROC, on which is recorded a computer program PROG in accordance with the invention. The computer program PROG includes instructions for performing the steps of a monitoring method in accordance with the invention and implemented by the monitoring device APP, when the computer program PROG is executed by the processor PROC.

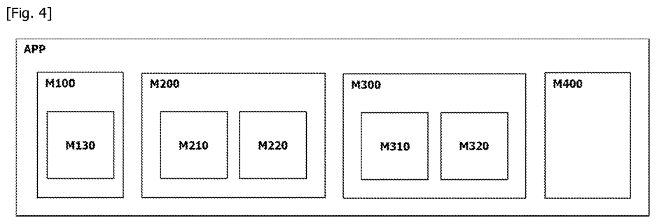

The computer program PROG defines functional and software modules of the monitoring device APP described hereinafter with reference to FIG. 4.

As illustrated by FIG. 1, according to an embodiment, the device APP possesses a communication module COM configured to communicate with the acquiring device SENS and/or the rendering device DISP. No limitation is attached to the nature of the communication interfaces between these devices, which can be wired or unwired, and can implement any protocol known to those skilled in the art.

FIG. 2 represents steps of a method for monitoring a rotary machine according to an embodiment of the invention. More precisely, this figure shows the operation of the monitoring device APP introduced with reference to FIG. 1.

As illustrated by FIG. 2, and according to an embodiment, the monitoring method for which provision is made comprises at least one of the steps S100 to S400 described hereinafter implemented by the monitoring device APP for which provision is made.

In the step S100, the monitoring device APP obtains the vibration signal SIG of the rotary machine MAC. In particular, the step S100 comprises, according to an embodiment, at least one of the following steps S110 to S130.

In the step S110, the monitoring device APP receives the vibration signal SIG, coming from the acquiring device SENS, and particularly by way of its communication module COM.

In a variant, the monitoring device APP could in the step S110 read the vibration signal from a memory shared with the acquiring device SENS.

In the step S120, the monitoring device APP obtains the reference signal REF (also known as tachometric signal) representative of the rotation of the reference shaft. For example, the monitoring device APP receives the reference signal REF, coming from the acquiring device SENS, and particularly by way of its communication module COM.

As mentioned previously, the reference signal REF can be acquired by a tachometer and thus represent the rotation of the reference shaft over time, and more specifically the frequency (i.e. the speed) of rotation of the reference shaft.

In the step S130, the monitoring device APP performs an angular resampling of the vibration signal x(t) by interpolating it with respect to the reference signal x_{ref}(t). The angular vibration signal thus obtained is written x(θ).

The angular resampling is done as a function of the rotation of the reference shaft to take into account any variations in the frequency (i.e. speed) of rotation of the rotary machine MAC during the acquisition time of the vibration signal x(t).

The method for which provision is made being applicable both to a time-domain or angular signal, hereinafter the notation x(u) will be used to denote the time-domain vibration signal x(t) or the angular vibration signal x(θ), u being a time-domain index t or an angular index θ.

In the context of the invention, embodiments could also be envisioned in which the acquiring device SENS supplies the angular vibration signal x(θ) directly as output, for example by performing the acquisition of samples at a fixed angular pitch of the rotary machine MAC.

In the step S200, the monitoring device APP, for at least one set of one or more parts of the rotary machine MAC, estimates the vibrational contribution of the set of parts from the vibration signal SIG. In other words, the monitoring device APP performs during this step a separation of the vibration sources.

The step S200 comprises at least one of the steps S210 and S220. Note that the monitoring method may comprise one or more iterations of the steps S200, S210 and S220.

In the step S210, the monitoring device APP estimates, for at least one subsystem S_{A}-S_{B} of the rotary machine MAC, the vibrational contribution SIG_{A} of the subsystem S_{A} from the vibration signal SIG. The implementation of the estimation made in the step S210 is described in more detail with reference to FIG. 3A.

En particulier, according to an embodiment, the monitoring device APP estimates the vibrational contribution of each of the subsystems S_{A}-S_{B} of the rotary machine MAC.

In the step S220, the monitoring device APP estimates, for at least one part L_{A1} of a subsystem S_{A}, the vibrational contribution SIG_{A1} of the part L_{A1} from the estimated vibrational contribution SIG_{A} of the subsystem S_{A}. The implementation of the estimation made in the step S220 is described in more detail with reference to FIG. 3B.

According to an embodiment, the monitoring device APP estimates the vibrational contribution SIG_{A1}-SIG_{A2} of each of the parts L_{A1}-L_{A2} of a subsystem S_{A}. Moreover, the monitoring device APP can estimate the vibrational contribution of each of the parts L_{A1}-L_{A2}, L_{B1}-L_{B2} of each of the subsystems S_{A}-S_{B} of the rotary machine MAC.

It should be emphasized that the monitoring device APP uses these kinematics F_{A}-F_{B} of the rotary machine MAC to estimate the vibrational contribution of a subsystem S_{A} and/or of a part L_{A1}. In particular, these kinematics F_{A}-F_{B} define the rotation frequency (in an absolute or relative manner) of the mechanical parts of the rotary machine MAC.

In the step S300, the monitoring device APP determines whether or not the rotary machine MAC is faulty. In other words, the monitoring device APP detects during this step the presence of a fault in the rotary machine MAC (e.g. a damaged part). For this purpose, the step S300 comprises at least one of the steps S310 and S320.

In the step S310, the monitoring device APP determines, for at least one subsystem S_{A} of the rotary machine MAC, whether or not the subsystem S_{A} is faulty by comparative analysis of the health indicator corresponding to the estimated vibrational contribution SIG_{A} of the subsystem S_{A}.

According to an embodiment, to detect a fault in a subsystem S_{A}, the monitoring device APP determines, from the estimated contribution SIG_{A} of the subsystem S_{A}, at least one health indicator representative of the presence of a fault in the subsystem S_{A} and compares said at least one health indicator to a threshold.

For example, a health indicator which can be used is the root mean square of the vibrational contribution. Specifically, the vibration of a damaged part is greater. For this reason, and according to an embodiment, the monitoring device APP determines that a subsystem S_{A} is faulty if the root mean square (over a given number of samples L) of the estimated vibrational contribution SIG_{A} of the subsystem S_{A} is greater than a threshold, e.g.

$$\sqrt{\frac{1}{L} {\sum }_{l = 0}^{L - 1} {{x}_{A} ( u - l )}^{2}} > λ .$$

In a variant, the monitoring device APP could use as health indicators the kurtosis and/or the skewness of the estimated vibrational contribution SIG_{A} (over a given number of samples). However, no limitation is attached to the nature of the health indicators used by the monitoring device APP.

According to an embodiment, the monitoring device APP determines, for each of the subsystems S_{A}-S_{B} of the rotary machine MAC, whether or not this subsystem S_{A}, S_{B} is faulty.

According to an embodiment, if (and only if) a fault of the subsystem S_{A} is detected in the step S310, the monitoring device APP implements the step S320. In other words, the detection of a fault of a subsystem S_{A} triggers the implementation of the step S320.

In the step S320, the monitoring device APP determines, for at least one part L_{A1} of a subsystem S_{A}, whether or not the part L_{A1} is faulty by comparative analysis of the health indicator corresponding to the estimated vibrational contribution SIG_{A1} of the part L_{A1}.

According to an embodiment, to detect a fault of a part L_{A1}, the monitoring device APP determines, from the estimated vibrational contribution SIG_{A1}, at least one so-called health indicator representative of the presence of a fault of the part L_{A1} and compares said at least one health indicator to a threshold.

In particular, the monitoring device APP can detect a fault in a part using a health indicator based on the root mean square as described above. However, in the context of the invention, embodiments could also be envisioned in which different health indicators are used as a function of the part analyzed during the step S320.

According to an embodiment, the monitoring device APP determines, for each of the parts L_{A1}-L_{A2} of a subsystem S_{A}, whether or not this part L_{A1}, L_{A2} is faulty, particularly if a fault of the subsystem S_{A} is detected in the step S310.

According to an embodiment, the monitoring device APP determines, for each of the parts L_{A1}-L_{A2}, L_{B1}-L_{B2} of the rotary machine MAC, whether or not this part is faulty.

In the step S400, if a fault of the rotary machine MAC is detected in the step S300, the monitoring device APP supplies at least one alert signal ALM.

According to an embodiment, if a fault of a subsystem S_{A} is detected in the step S310, said at least one alert signal ALM comprises: an identifier of the faulty subsystem S_{A}; and the vibrational contribution SIG_{A} of the faulty subsystem S_{A}. Moreover, according to an embodiment, if a fault in a part L_{A1} of a subsystem S_{A} is detected in the step S320, said at least one alert signal ALM comprises: an identifier of the faulty part L_{A1}; and the vibrational contribution SIG_{A} of the faulty part L_{A1}.

Preferably, the alert signal ALM comprises: an identifier of the subsystem and the vibrational contribution SIG_{A} of the faulty subsystem S_{A}; and an identifier and the vibrational contribution SIG_{A} of the faulty part L_{A1}. In this sense, the alert signal ALM can be qualified as an alert signal with two levels, with one subsystem system and a part level.

As previously described, and according to an embodiment, the monitoring device APP transmits the alert signal ALM to the rendering device DISP, particularly by way of its communication module COM.

In addition, according to an embodiment, the monitoring device APP supplies as output the health indicators determined during the steps S310 and S320.

FIG. 3A shows steps of a monitoring method of a rotary machine according to an embodiment of the invention. This figure details the step S210 of estimating the vibrational contribution SIG_{A} of a subsystem S_{A} from the vibration signal SIG.

It is here recalled that, to separate the different vibration sources, the monitoring device APP makes use of the kinematics of the rotary machine MAC and that these kinematics define the different frequencies (i.e. speeds) of rotation of the mechanical parts of the rotary machine MAC. In particular, we write F_{A} the set of rotation frequencies F_{A1}-F_{A2} of the parts L_{A1}-L_{A2} of a subsystem S_{A}.

Furthermore, the rotation frequencies F_{A1}-F_{A2} of the parts L_{A1}-L_{A2} can be defined in a relative manner with respect to the rotation frequency of a machine reference shaft. For example, f_{A1}=L_{A1}·f_{ref} with: f_{A1}, the rotation frequency F_{A1} of a part L_{A1}; and f_{ref}, the rotation frequency of the reference shaft; and i_{A1}, said order associated with the part L_{A1}.

In the step S210, the monitoring device APP estimates, for at least one subsystem S_{A} of the rotary machine MAC, the vibrational contribution SIG_{A} of the subsystem S_{A} from the vibration signal SIG. To do so, according to the embodiment illustrated by FIG. 3A, the step S210 comprises at least one of the steps S211 to S213.

In the step S211, the monitoring device APP determines a signal s_{A}(u) associated with the subsystem S_{A} under consideration and expressed by:

$${s}_{A} ( u ) = {\sum }_{{f}_{i} ∈ {F}_{A}} {m}_{x} ( {f}_{i} , u ) , \qquad Eq . ( 1 )$$

with mₓ(fᵢ,u), the synchronous averages of the vibration signal x(u) associated with the frequency fᵢ defined by:

$${m}_{x} ( {f}_{i} , u ) = \frac{1}{N} {\sum }_{n = 0}^{N - 1} x ( u - n \cdot {M}_{{f}_{i}} ) , \qquad Eq . ( 2 )$$

where N is a number of averaged samples (i.e. a number of averaged sections) of the vibration signal SIG, and M_{fi} is the number of samples of the vibration signal SIG per period associated with the frequency fᵢ. For example, the number of samples M_{fi}=Fₛ/fᵢ, with Fₛ the sampling frequency of the vibration signal SIG.

In the expression above, the synchronous averages M_{A1}-M_{A2} allow to extract the frequency components (i.e. the fundamental frequency and the harmonics) of the vibrational contribution of each of the parts L_{A1}-L_{A2} of the subsystem S_{A}. However, it should be emphasized that certain frequency components are shared by several parts L_{A1}-L_{A2} of the subsystem S_{A}, thus characterizing the interference between these parts such as previously discussed.

Thus, by summing the vibrational contributions of each of the parts L_{A1}-L_{A2} of the subsystem S_{A} as described in equation 1, the frequency components shared by several parts are taken into account several times. In other words, the interference between the parts L_{A1}-L_{A2} of the subsystem S_{A} is replicated.

Consequently, the obtained signal s_{A}(u) comprises: the vibrational contribution of the subsystem S_{A} under consideration; and the replication of the interference between the parts L_{A1}-L_{A2} of the subsystem S_{A}.

In the step S212, the monitoring device APP determines a signal r_{A}(u) using the following expression:

$${r}_{A} ( u ) = {\sum }_{{f}_{i} ∈ {F}_{A}} {{\sum }_{{f}_{j} ∈ {F}_{A}}}_{{f}_{j} > {f}_{i}} {m}_{x} ( φ ( {f}_{i} , {f}_{j} ) , u ) , \qquad Eq . ( 3 )$$

with φ(fᵢ,fⱼ), the lowest frequency that is a multiple of fᵢ and of fⱼ. More precisely, this gives: φ(fᵢ,fⱼ)=k·fᵢ, with k an integer greater than 1; and φ(fᵢ,fⱼ)=p·fⱼ+ε, with p an integer greater than 1 and |ε|<Δ a margin of error related to a numerical approximation.

The synchronous average M_{A1,A2} associated with the lowest frequency (or order) that is a multiple of the rotation frequencies F_{A1} and F_{A2} of two parts L_{A1} and L_{A2} of the subsystem S_{A} allows to extract the frequency components shared by the two parts L_{A1} and L_{A2}.

Hence, the signal r_{A}(u) is representative of the interference between the parts L_{A1}-L_{A2} of the subsystem S_{A}.

Typically, for the parts L_{A1}-L_{A2} of a subsystem S_{A}, the values {φ(fᵢ,fⱼ)|fᵢ∈F_{A},fⱼ∈F_{A}} are stored in a so-called shared order matrix. As indicated in the equation 3, only the values φ(fᵢ,fⱼ) with fᵢ>fⱼ are used such that the shared order matrix is an upper triangular matrix.

When the parts L_{A1}-L_{A2} of a subsystem S_{A} are mechanically connected to the reference shaft by way of one or more gears, the values {φ(fᵢ,fⱼ)} may be obtained (particularly analytically) by the number of teeth of the parts L_{A1}-L_{A2} of the subsystem S_{A} and by the rotation frequency of the reference shaft f_{ref}.

In a variant, for two parts L_{A1} and L_{A2} of a subsystem S_{A}, the value φ(f_{A1},f_{A2}) can be determined by the rotation frequencies f_{A1} and f_{A2} of the parts using a numerical search algorithm.

In the step S213, the monitoring device APP estimates the vibrational contribution SIG_{A} of the subsystem S_{A} written x_{A}(u) using the following expression:

$${x}_{A} ( u ) = {s}_{A} ( u ) - {r}_{A} ( u ) , \qquad Eq . ( 4 )$$

It is recalled here that the signal S_{A}(u) comprises both the vibrational contribution of the subsystem S_{A} under consideration and the replication of the interference between the parts L_{A1}-L_{A2} of the subsystem S_{A}. Thus, by removing from the signal S_{A}(u) the replication of the interference r_{A}(u), an estimate of the vibrational contribution SIG_{A} of the subsystem S_{A} under consideration is obtained.

The vibrational contribution SIG_{A} of the subsystem S_{A} is then used in the step S310 to determine whether or not the subsystem S_{A} under consideration is faulty.

As described above, the vibrational contribution SIG_{A} of the subsystem S_{A} is estimated based on: synchronous averages M_{A1}-M_{A2} (said first synchronous averages) associated with the rotation frequencies F_{A1}-F_{A2} of the parts L_{A1}-L_{A2} of the subsystem S_{A}; and synchronous averages M_{A1,A2} (said second synchronous averages) associated with multiples of the rotation frequencies F_{A1}-F_{A2} of the parts L_{A1}-L_{A2} and shared by at least two parts of the subsystem. However, in the context of the invention, it could also be envisioned to estimate the vibrational contribution of a subsystem based on the first and second synchronous averages using expressions other than that defined by the equation (4) above. For example, it could be envisioned to use a neural network (or another machine learning algorithm) taking as input the first and second synchronous averages, and supplying as output the estimated vibrational contribution of the subsystem.

FIG. 3B shows steps of a method for monitoring a rotary machine according to an embodiment of the invention. This figure in particular details the step S220 of estimating the vibrational contribution of a part L_{A1} from the vibrational contribution of a subsystem SIG_{A}.

In the step S220, the monitoring device APP estimates, for at least one part L_{A1} of a subsystem S_{A} of the rotary machine MAC, the vibrational contribution SIG_{A1} of the part L_{A1} from the estimated vibrational contribution SIG_{A} of the subsystem S_{A}. For this purpose, according to the embodiment illustrated by FIG. 3B, the step S220 comprises at least one of the steps S221 to S223.

In the step S221, the monitoring device APP determines a signal s_{A1}(u) associated with the part L_{A1} under consideration and expressed by:

$${s}_{A 1} ( u ) = {m}_{{x}_{A}} ( {f}_{A 1} , u ) , \qquad Eq . ( 5 )$$

with: f_{A1}, the rotation frequency of the part L_{A1}; and mₓ(f_{A1},u), the synchronous average N_{A1} of the vibrational contribution x(u) of said subsystem associated with the frequency f_{A1} and defined by:

$${m}_{{x}_{A}} ( {f}_{A 1} , u ) = \frac{1}{N} {\sum }_{n = 0}^{N - 1} {x}_{A} ( u - n \cdot {M}_{{f}_{A 1}} ) , \qquad Eq . ( 6 )$$

The synchronous average N_{A1} allows to extract the frequency components of the vibrational contribution of the part L_{A1}. However, certain frequency components are shared by the part L_{A1} and by other parts L_{A2} of the subsystem S_{A}, thus characterizing the interference between these parts.

Hence, the obtained signal s_{A1}(u) comprises: the vibrational contribution of the part L_{A1} under consideration; and the interference between the part L_{A1} and the other parts of the subsystem S_{A}.

In the step S222, the monitoring device APP determines a signal r_{A1}(u) representative of the interference between the part L_{A1} under consideration and the other parts of the subsystem S_{A}. The signal r_{A1}(u) is obtained using the following expression:

$${r}_{A 1} ( u ) = {{\sum }_{{f}_{j} ∈ {F}_{A}}}_{{f}_{j} \neq {f}_{A 1}} {m}_{{x}_{A}} ( φ ( {f}_{A 1} , {f}_{j} ) , u ) , \qquad Eq . ( 7 )$$

with φ(f_{A1},fᵢ), the lowest frequency that is a multiple of f_{A1} and of fⱼ.

The synchronous average N_{A1,A2} associated with the lowest frequency that is a multiple of the rotation frequencies F_{A1} and F_{A2} of the part L_{A1} and of another part L_{A2} of the subsystem S_{A} allows to extract the frequency components shared by the two parts L_{A1} and L_{A2}. Thus, the signal r_{A1}(u) allows to describe the interference between the part L_{A1} under consideration and the other parts L_{A2} of the subsystem S_{A}.

In the step S223, the monitoring device APP estimates the vibrational contribution SIG_{A1} of the part L_{A1} written x_{A1}(u) using the following expression:

$${x}_{A 1} ( u ) = {s}_{A 1} ( u ) - {r}_{A 1} ( u ) , \qquad Eq . ( 8 )$$

As mentioned above, the signal s_{A1}(u) allows to extract the frequency components of the vibrational contribution of the part L_{A1}, but certain of these frequency components are shared by the part L_{A1} and by other parts L_{A2} of the subsystem S_{A}. For this reason, provision is made here for eliminating the interference r_{A1}(u) from the signal s_{A1}(u), which allows to isolate the exclusive vibrational contribution SIG_{A1} of the part L_{A1} under consideration.

The vibrational contribution SIG_{A1} of the part L_{A1} is then used in the step S320 to determine whether or not the part L_{A1} under consideration is faulty.

According to an embodiment, if a fault in the part L_{A1} under consideration is detected, the monitoring device APP uses the signal r_{A1}(u) representative of the interference to determine whether or not the fault propagates (i.e. emerges) in other parts L_{A2} of the subsystem S_{A}. For this purpose, the monitoring device APP determines at least one health indicator for the signal r_{A1}(u) and compares said at least one health indicator to a threshold.

As described above, the vibrational contribution SIG_{A1} of the part L_{A1} of the subsystem S_{A} is estimated based on: the synchronous average N_{A1} (said third synchronous average) associated with the rotation frequency F_{A1} of the part L_{A1}; and synchronous averages N_{A1,A2} (said fourth synchronous averages) associated with multiples of the rotation frequency F_{A1} of the part L_{A1} shared by the part L_{A1} and by at least one other part L_{A2} of the subsystem S_{A}. However, in the context of the invention, it could also be envisioned to estimate the vibrational contribution of a part of a subsystem based on the third and fourth synchronous averages using expressions other than that defined by the equation (8) above. For example, it could be envisioned to use a neural network (or another machine learning algorithm) taking as input the third and fourth synchronous averages, and supplying as output the estimated vibrational contribution of the part.

FIG. 4 shows an example of a functional architecture of a device for monitoring a rotary machine according to an embodiment of the invention.

In general, the monitoring device APP comprises modules respectively configured to implement each of the steps of a monitoring method in accordance with the invention.

In particular, and as illustrated by FIG. 4, the monitoring device APP for which provision is made comprises, according to an embodiment, at least one of the following modules:
an obtaining module M100 configured to obtain a vibration signal SIG of the rotary machine, particularly comprising:
   a resampling module M130 configured to perform an angular resampling S130 of the vibration signal SIG by interpolation of the vibration signal SIG with respect to the reference signal REF representative of the rotation of a reference shaft;
an estimating module M200 configured to estimate the vibrational contribution of a set of one or more parts of the rotary machine MAC based on the vibration signal SIG, comprising at least one of the following modules:
   a module for estimating vibrations of a subsystem M210 configured to estimate the vibrational contribution SIG_{A} of a subsystem S_{A}-S_{B} of the rotary machine MAC based on the vibration signal SIG; and
   a module for estimating vibrations of a part M220 configured to estimate the vibrational contribution SIG_{A1} of a part L_{A1} of a subsystem S_{A} of the rotary machine MAC from the vibrational contribution SIG_{A} of the subsystem S_{A};
a module M300 for detecting faults configured to detect a fault of the rotary machine MAC, comprising at least one of the following modules:
   a module for detecting a fault of a subsystem M310 configured to determine whether or not a subsystem S_{A}-S_{B} of the rotary machine MAC is faulty and by comparative analysis of the health indicator corresponding to the estimated vibrational contribution SIG_{A}-SIG_{B} of the subsystem S_{A}-S_{B}; and
   a module for detecting a fault of a part M320 configured to determine whether or not a part L_{A1}-L_{A2} of a subsystem S_{A} of the rotary machine MAC is faulty and by comparative analysis of the health indicator corresponding to the estimated vibrational contribution SIG_{A1}-SIG_{A2} of the part L_{A1}-L_{A2}; and
a supplying module M400 configured to supply one or more alert signals ALM if a fault of the rotary machine MAC is detected.

The term “module” can correspond equally to a software component and to a hardware component or a set of hardware and software components, a software component itself corresponding to one or more computer programs or subprograms or more generally to any element of a program able to implement a function or a set of functions as described for the modules in question. In the same way, a hardware component corresponds to any element of a hardware assembly able to implement a function or a set of functions for the module in question (integrated circuit, chip card, memory card, etc.).

Note that the order in which the steps of a method in accordance with the invention follow one another, particularly with reference to the appended drawings, constitutes only an exemplary embodiment without any limitation, variants being possible. In particular, a method in accordance with the invention may comprise one or more iterations of the steps described above, particularly with reference to the drawings attached. Moreover, the reference symbols are not limiting of the scope of the protection, their sole function being to simplify the understanding of the claims.

1. A method for monitoring a rotary machine (MAC) based on a vibration signal (SIG), the rotary machine (MAC) comprising a plurality of subsystems (S_{A}-S_{B}) of mechanical parts in rotation (L_{A1}-L_{A2}, L_{B1}-L_{B2}) and the vibration signal (SIG) comprising vibrational contributions of the subsystems (S_{A}-S_{B}), the method comprising, for at least one said subsystem (S_{A}), steps consisting in:
estimating (S210) the vibrational contribution of said subsystem (S_{A}) from a set of synchronous averages of the vibration signal (SIG) comprising:
first synchronous averages (M_{A1}-M_{A2}) associated with rotation frequencies (F_{A1}-F_{A2}) of the parts of said subsystem (L_{A1}-L_{A2}); and
one or more second synchronous averages (M_{A1,A2}) associated with multiples of the rotation frequencies (F_{A1}-F_{A2}) of the parts of said subsystem (L_{A1}-L_{A2}), these multiples being shared by at least two parts of said subsystem (L_{A1}-L_{A2}); and in
determining (S310) whether or not said subsystem (S_{A}) is faulty by comparative analysis of a so-called health indicator corresponding to the estimated vibrational contribution (SIG_{A}) of said subsystem (S_{A}).

2. The method according to claim 1, wherein the vibrational contribution (SIG_{A}) of said subsystem (S_{A}) is estimated (S310) based on a difference between: a sum of said first synchronous averages (M_{A1}-M_{A2}); and a sum of said one or more second synchronous averages (M_{A1,A2}).

3. The method according to claim 2, wherein the estimated contribution (SIG_{A}) of said subsystem (S_{A}) is expressed by:
$${x}_{A} ( u ) = {\sum }_{{f}_{i} ∈ {F}_{A}} {m}_{x} ( {f}_{i} , u ) - {\sum }_{{f}_{i} ∈ {F}_{A}} {{\sum }_{{f}_{j} ∈ {F}_{A}}}_{{f}_{j} > {f}_{i}} {m}_{x} ( φ ( {f}_{i} , {f}_{j} ) , u ) ,$$
with: u, a time-domain or angular index; F_{A}, the rotation frequencies (F_{A1}-F_{A2}) of the parts (L_{A1}-L_{A2}) of said subsystem (S_{A}); φ(fᵢ,fⱼ), the lowest frequency that is a multiple of fᵢ and of fⱼ; and mₓ(fᵢ,u) the synchronous average of the vibration signal x(u) associated with the frequency fᵢ and defined by:
$${m}_{x} ( {f}_{i} , u ) = \frac{1}{N} {\sum }_{n = 0}^{N - 1} x ( u - n \cdot {M}_{{f}_{i}} ) ,$$
where N is a number of averaged samples, and M_{fi} is a number of samples for a period associated with the frequency fᵢ.

4. The method according to one of claims 1 to 3, comprising for at least one part (L_{A1}) of said subsystem (S_{A}) steps consisting in:
estimating (S220) the vibrational contribution (SIG_{A1}) of said part (L_{A1}) from a set of synchronous averages of the estimated vibrational contribution (SIG_{A}) of said subsystem (S_{A}) comprising:
a third synchronous average (N_{A1}) associated with a rotation frequency (F_{A1}) of said part (L_{A1}); and
one or more fourth synchronous averages (N_{A1,A2}) associated with multiples of the rotation frequency (F_{A1}) of said part (L_{A1}), these multiples being shared by said part (L_{A1}) and by at least one other part (L_{A2}) of said subsystem (S_{A}); and by
determining (S320) whether or not said part (L_{A1}) is faulty by comparative analysis of a so-called health indicator corresponding to the estimated contribution (SIG_{A1}) of said part (L_{A1}).

5. The method according to claim 4, wherein the vibrational contribution (SIG_{A1}) of said part (L_{A1}) is estimated (S220) based on a difference between: said third synchronous average (N_{A1}); and a sum of said one or more fourth synchronous averages (N_{A1,A2}).

6. The method according to claim 5, wherein the estimated contribution (SIG_{A1}) of said part (L_{A1}) is expressed by:
$${x}_{A 1} ( u ) = {m}_{{x}_{A}} ( {f}_{A 1} , u ) - {{\sum }_{{f}_{j} ∈ {F}_{A}}}_{{f}_{j} \neq {f}_{A 1}} {m}_{{x}_{A}} ( φ ( {f}_{A 1} , {f}_{j} ) , u )$$
with: u, a time-domain or angular index; f₁, the rotation frequency of said part (L_{A1}); F_{A}, the rotation frequencies (F_{A1}-F_{A2}) of the parts of said subsystem (L_{A1}-L_{A2}); φ(f_{A1},fⱼ), the lowest frequency that is a multiple of f_{A1} and of fⱼ; and mₓ_{_{A}}(fᵢ,u), the synchronous average of the vibrational contribution x_{A}(u) of said subsystem (S_{A}) associated with the frequency fᵢ and defined by:
$${m}_{{x}_{A}} ( {f}_{i} , u ) = \frac{1}{N} {\sum }_{n = 0}^{N - 1} {x}_{A} ( u - n \cdot {M}_{{f}_{i}} ) ,$$
where N is a number of averaged samples, and M_{fi} is a number of samples for a period associated with the frequency fᵢ.

7. The method according to one of claims 4 to 6, wherein if a fault in a said subsystem (S_{A}) is detected (S310), the method comprises for each of the parts (L_{A1}-L_{A2}) of the subsystem a step (S320) consisting in: determining whether or not said part (L_{A1}) is faulty by comparative analysis of a so-called health indicator corresponding to the estimated contribution (SIG_{A1}) of said part.

8. The method according to one of claims 1 to 7, comprising a step (S130) of angular resampling of the vibration signal (SIG) by interpolation of the vibration signal with respect to a reference signal (REF) representative of the rotation of a reference shaft of the rotary machine (MAC).

9. The method according to one of claims 1 to 8, comprising, if a fault of a said subsystem (S_{A}) is detected (S310), a step consisting in supplying (S400) an alert signal (ALM) comprising at least one identifier and the estimated vibrational contribution (SIG_{A}) of the faulty subsystem (S_{A}).

10. A device for monitoring a rotary machine (MAC) based on a vibration signal (SIG), the device (APP) comprising:
an estimating module (M210) configured to estimate the vibrational contribution of a subsystem (S_{A}) of the rotary machine (MAC) from a set of synchronous averages of the vibration signal (SIG) comprising:
first synchronous averages (M_{A1}-M_{A2}) associated with rotation frequencies (F_{A1}-F_{A2}) of the parts of said subsystem (L_{A1}-L_{A2}); and
one or more second synchronous averages (M_{A1,A2}) associated with multiples of the rotation frequencies (F_{A1}-F_{A2}) of the parts of said subsystem (L_{A1}-L_{A2}), these multiples being shared by at least two parts of said subsystem (L_{A1}-L_{A2}); and
a fault detecting module (M310) configured to determine whether or not a said subsystem (S_{A}) is faulty by comparative analysis of a so-called health indicator corresponding to the estimated contribution (SIG_{A}) of said subsystem (S_{A}).

11. A monitoring system (SYS) comprising an acquiring device (SENS) configured to acquire a vibration signal (SIG) and a monitoring device (APP) according to claim 10.

12. The system (SYS) according to claim 11, wherein the acquiring device (SENS) comprises an accelerometer or a microphone.

13. An aircraft (AC) comprising a rotary machine (MAC) and a monitoring system (SYS) according to claim 11 or 12.

14. The aircraft (AC) according to claim 13, wherein the rotary machine (MAC) is a combustion engine or an internal combustion engine.

15. A computer program (PROG) including instructions for implementing the steps (S100-S400) of a monitoring method according to any of claims 1 to 9, when said computer program (PROG) is executed by at least one processor (PROC).
